(19) United States
(12) Patent Application Publication
(10) Pub. No.: US 2015/0079276 A1
(43) Pub. Date: Mar. 19, 2015

(54) METHOD OF FORMING A CONDUCTIVE IMAGE USING HIGH SPEED ELECTROLESS PLATING

(71) Applicant: EARTHONE CIRCUIT TECHNOLOGIES CORPORATION, Carlsbad, CA (US)

(72) Inventor: William Wismann, Camarillo, CA (US)

(21) Appl. No.: 14/453,559

(22) Filed: Aug. 6, 2014

Related U.S. Application Data
(60) Provisional application No. 61/862,924, filed on Aug. 6, 2013.

(51) Int. Cl. C23C 18/16; C03C 17/10; C23C 18/40

(52) U.S. Cl. CPC C23C 18/1608; C23C 18/1639; C23C 18/405; C03C 17/10
USPC 427/123

(57) ABSTRACT

A method of producing a conductive image using high speed electroless plating according to the present invention preferably includes the steps of: preparing the surface of a substrate; depositing a metal coordination complex into the surface of the substrate; reducing the metal coordination complex to form an image in the surface of the substrate; depositing a protective material onto the image; electrolessly plating metal onto the image.

### CROSS REFERENCE TO RELATED APPLICATIONS

This application is based on U.S. Provisional Application No. 61/862,924, filed Aug. 6, 2013, the entire contents and disclosure of which are herein incorporated by reference.

### BACKGROUND OF THE INVENTION

This invention relates to a high speed electroless plating solution, a method of producing the same with specific focus on the field of electronics.

In the manufacturing of electronic devices the degree of density increases and the size of the traces and spaces between the trace line decreases, all of which must be formed on a substrate. As the density of the trace line increases, the net resistance of the conductive material is substantially increased overall. The increase in resistance in the conductive traces of electronic devices causes the quality of the devices to deteriorate due to signal delay. Therefore, it is desirable to decrease the resistance of plated conductive trace line.

Copper as a conductive material has relatively low specific resistance and excellent electro-migration resistance. When copper is specified for the conductive material set within an electronic device, it is preferred that current capacity will remain unaffected relative to the miniaturization and high integration density of the smaller devices, that is now desirable. Electroless plating is a method of plating a conductive material or metal by the reaction of reducing and oxidizing in solution to provide the conductive material or metal on the surface of an activated or pretreated substrate. By using the electroless plating method of plating, the metal is uniformly and simultaneously deposited throughout the entire substrate. Electroless plating does not use an external power source (as does electrolytic plating), in which homogeneity of plating is enhanced.

Commonly, an electroless copper plating solution contains a source of cupric ions, a complexing agent for cupric ions, a reductant for cupric ions, and a pH adjusting agent. When copper plating was performed using the electroless copper plating solution, obtaining a plating film having high adhesion was difficult, the speed of forming a metal plating film was low, and uniform plating of the entire substrate was difficult.

Additionally, the electroless copper plating solution could contain a stabilizer(s) for improving the stability of the plating bath, a surfactant for improving the properties of the plating film, along with various additives which can be added to the electroless copper plating solution, so as to improve the stability and material properties of the plating solution and the characteristics of the copper image (pattern) designed. However, conventional electroless copper plating solutions have provided a copper deposition that displays both sufficiently low electrical resistance and excellent bonding. The simple mechanism of the electroless copper plating solution is when a reducing agent in solution causes an oxidation reaction with a catalytic action of copper.

To briefly explain the mechanism of the electroless copper plating, the reducing agent in the plating bath causes an oxidation reaction with a catalytic action of copper, which releases electrons. Consequently, the cupric ion is reduced by receiving the released electrons, and depositing a copper plating on the substrate in the solution.

In the plating industry, practically all of the electroless copper solutions/baths utilized formaldehyde as a reducing agent. Unfortunately, formaldehyde is a toxic chemistry and a carcinogen, and is not environmentally favorable in the electronic industry. With respect to formaldehyde as an issue, it has been suggested to use glyoxylic acid instead of formaldehyde in the electroless copper plating solution/bath. However, the oxidation reaction of glyoxylic acid is slower, and it is probably caused by the catalytic action of copper. Glyoxylic acid releases fewer electrons from the oxidation reaction, and consequently the plating reaction ensues slower in the electroless copper plating solution/bath using glyoxylic acid as the reducing agent. The objective of which was to provide an electroless copper plating solution/bath that would be less toxic and more consistently stable in production.

Predominantly, the normal electroless copper plating solution/bath uses a solution containing ethylenediamine tetraacetate (EDTA) as a complexing agent. EDTA is also slow in the deposition rate of the copper, so that it is essential to increase the speed of the deposition rate of the electroless copper. Since the time required for the plating is longer, then the production efficiency is lowered, which causes a challenge to overcome, or the need for a high speed electroless copper solution/bath.

As the electronic device dimensions are manufactured smaller and smaller, the aspect ratio of vias and 3D features (such as trenches) are designed with higher density and narrower traces and spaces (line width and space), processes will need to be developed to feed the drive of the designers. Conventional processes for depositing copper into these features include physical vapor deposition (PVD), chemical vapor deposition (CVD), atomic layer deposition (ALD), and electroplating. These processes have their innate challenges that electroless plating can overcome. Electroless copper plating holds great promise as a method to form a copper trace or line for Ultra large Scale Integration (ULSI), and as a replacement for the sputtering, vapor deposition and electrolytic copper plating systems presently employed.

It is a purpose of this innovation to solve the above mentioned challenges of the conventional techniques and to offer a practice or a system for electroless plating capable of improving the deposition and acceleration of the electroless plating solutions/baths.

An additive process is needed for printed circuit board fabrication that has all of the benefits of other additive processes but which displays enhanced bonding characteristic with substrates. The current invention provides such an additive process.

### SUMMARY OF THE INVENTION

A method of forming a conductive image using high speed electroless plating is described herein that overcomes the limitations noted above.

A method of conductive image using high speed electroless plating according to the present invention preferably includes the steps of: preparing the surface of a substrate; depositing a metal coordination complex into the surface of the substrate; reducing the metal coordination complex to form an image in the surface of the substrate; depositing a protective material onto the image; electrolessly plating metal onto the image. Accordingly, electroless plating may be accomplished at a high speed and efficacy.

Various features and advantages of the present invention will become apparent from the following more detailed description, taken in conjunction with the accompanying drawings, which illustrate, by way of example, the principles of the presently described process and its resultant product.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is an illustrative flow-chart of an exemplary method in accordance with at least one embodiment of the present invention;

FIG. 2 illustrates an exemplary bonding in the surface of the substrate in accordance with at least one embodiment of the present invention; and

FIG. 3 illustrates exemplary tuned magnetic field states (FIGS. 3A to 3D) in accordance with at least one embodiment of the present invention.

### DETAILED DESCRIPTION OF THE PREFERRED EMBODIMENTS

The above described drawing figures illustrate the described invention in at least one of its preferred, best mode embodiments, which is further defined in detail in the following description. Those having ordinary skill in the art may be able to make alterations and modifications to what is described herein without departing from its spirit and scope. While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. Therefore, it should be understood that what is illustrated is set forth only for the purposes of example and should not be taken as a limitation on the scope of the present apparatus and its method of use.

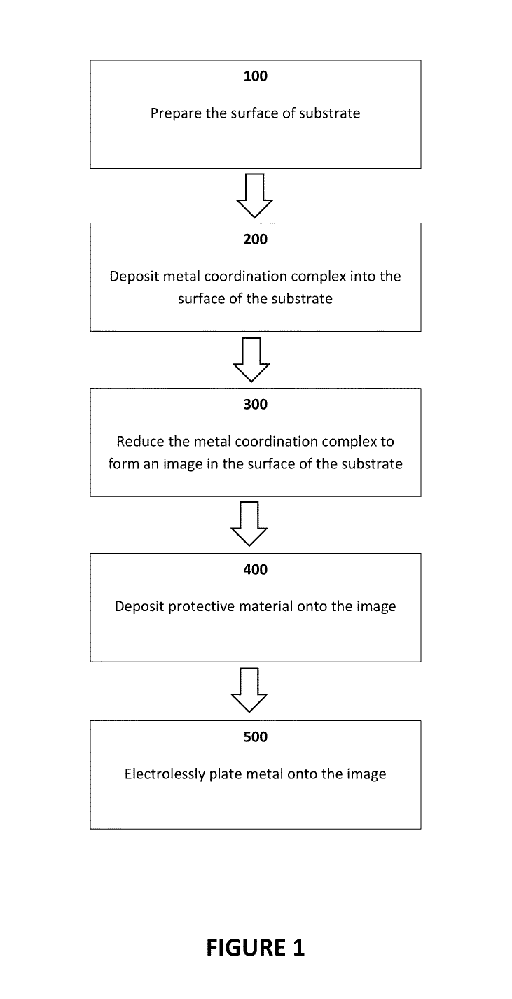

As shown in FIG. 1, in at least one embodiment, a method for forming a conductive image using high speed electroless plating comprises the steps of: preparing the surface of a substrate; depositing a metal coordination complex into the surface of the substrate; reducing the metal coordination complex to form an image in the surface of the substrate; depositing a protective material onto the image; electrolessly plating metal onto the image. As used herein, a “conductive image” refers to an electrically conductive surface pattern, for example and without limitation, that of a printed circuit.

### Preparing the Substrate (Step 100)

As shown in FIG. 1, at least a portion of the substrate surface is prepared to be electrolessly plated with metal in accordance with Step 100.

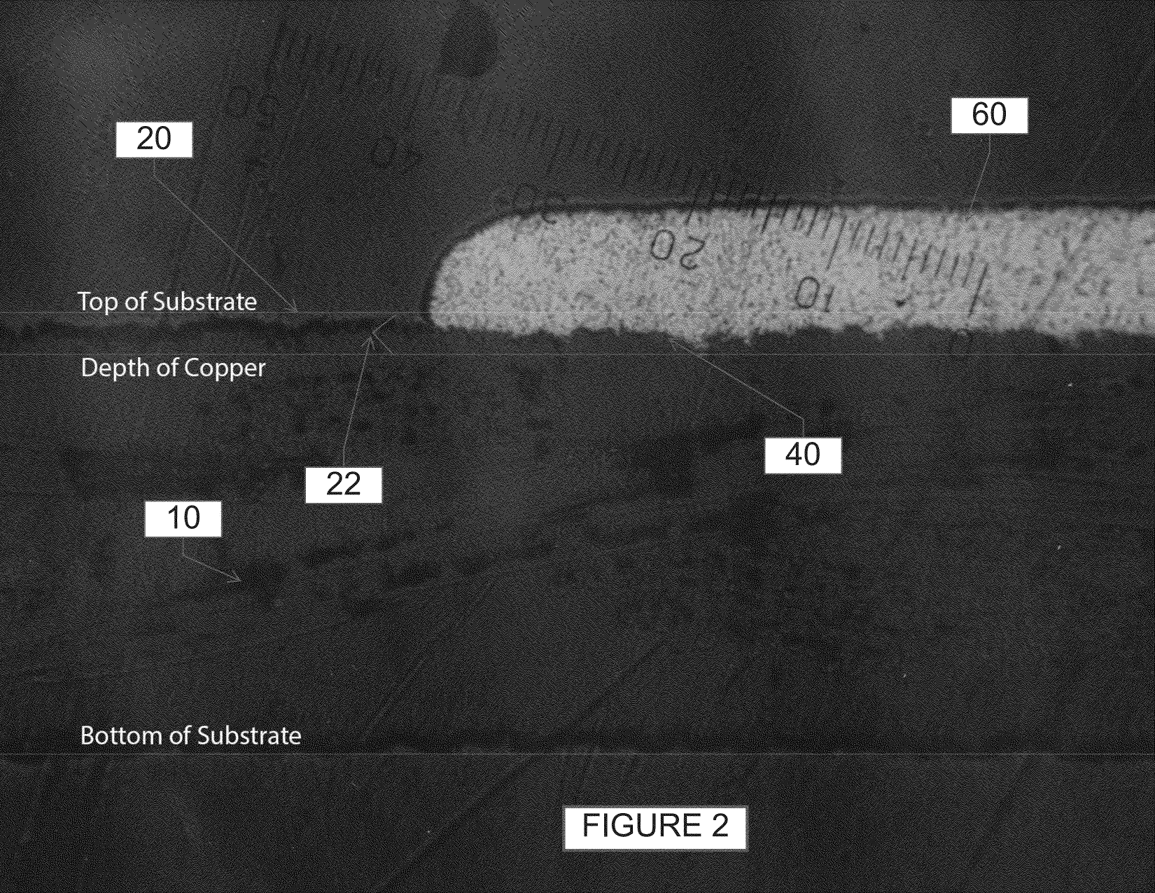

As shown in FIG. 2, according to at least one embodiment, a substrate 10 having a surface 20 with a thickness 22 is provided and at least a portion of the substrate surface is prepared to be electrolessly plated with metal. As used herein, the term “at least a portion of the substrate surface” refers to the entire substrate surface or any portion thereof. Preferably, the substrate is a non-conductive substrate such as, for example, glass, silicone or polymer. In at least one embodiment, preparing the substrate surface to be electrolessly plated with metal includes at least one of: pretreating the portion the substrate surface, and activating the portion of the substrate surface.

Returning to FIG. 1, in at least some embodiments, the step of preparing the substrate surface includes pre-treating the portion of the substrate surface, i.e. removing unwanted material from the portion of the substrate surface whose presence during the process of the instant invention may result in poor plating. Pretreatment of the substrate surface may be accomplished according to known methods in the art.

In at least some embodiments, the step of preparing the portion of the substrate surface includes activating the portion of the substrate surface, i.e. rendering the substrate surface more amenable to interaction with and subsequent physical or chemical bonding to another material that is disposed onto the surface of the substrate. Activating the substrate surface may comprise altering the topography of the substrate surface and/or rendering the substrate surface more diffusive to incident electromagnetic radiation.

In at least one embodiment, activating the substrate surface comprises altering the topography of the substrate surface. The topography of the surface can be altered by any means known in the art or hereinafter developed, including mechanical, chemical, plasma, laser or a combination thereof. In at least one embodiment, the topography of the substrate surface may be altered via etching, including mechanical, chemical, plasma or laser etching.

Mechanically altering the substrate surface topology includes, for example, molding the substrate with the desired topology. In such embodiments, molten substrate material may be deposited into a mold that imparts the desired surface topology to the produced substrate.

Chemically altering the substrate surface topology includes, for example, acid etching, base etching, oxidative etching and plasma etching. Acid etching refers to the use of a strong acid to alter the surface properties of the surface of the substrate, typically glass, and is known in the art. Base etching refers to the use of a basic substance to alter the topology of the surface of the substrate, typically organic polymers, and is known in the art. Oxidative etching refers to the use of a strong oxidant to alter the surface properties of the surface of the substrate, and is known in the art.

Altering the substrate surface topology using plasma includes, for example, plasma etching. Plasma etching refers to the process of impacting the surface of a substrate with a high-speed stream of a glow discharge of an appropriate gas, and is known in the art.

Altering the substrate surface topology using laser includes, for example, laser etching. Laser etching refers to the process of directing a laser beam at the substrate surface so as to remove material from the substrate surface.

In at least one embodiment, the topography of the substrate surface may be altered in the form of a predetermined pattern or designed topography. As discussed further herein, the predetermined pattern may form a trace for the image formed in the substrate surface. This is particularly applicable where laser etching is used to prepare the substrate surface.

In at least one embodiment, activating the substrate surface comprises rendering the substrate surface more diffusive, i.e. permeable to another material that is disposed into the surface of the substrate. In such embodiments, the surface of the substrate may be exposed to a fluid that softens and/or swells the substrate surface, permitting material applied to the surface to physically interact within the surface (i.e. within the surface thickness), and resulting in the material being more tightly bonded to the substrate surface—particularly when dried.

### Depositing the Metal Coordination Complex (Step 200)

As shown in FIG. 1, a metal coordination complex is deposited into the surface of the portion of the substrate surface in accordance with Step 200.

According to at least one embodiment, a metal coordination complex is provided for deposition into (i.e. within the thickness of) the substrate surface. As used herein, the term “metal coordination complex” refers to those metal complexes understood by those of skill in the art to have the desired properties described herein. Preferably, the metal coordination complex is a para-magnetic or ferro-magnetic metal coordination complex. An exemplary metal coordination complex is described, for example, in U.S. Pat. No. 8,784,952 and U.S. Pat. No. 8,784,953, the entire contents and disclosures of which are herein incorporated by reference.

In at least one embodiment, the metal coordination complex is a ferromagnetic coordination complex, including iron, nickel or cobalt, preferably iron. In at least one embodiment, the metal coordination complex is a paramagnetic coordination complex, including tungsten, cesium, aluminum, lithium, magnesium, molybdenum, tantalum, preferably aluminum or molybdenum. In at least one embodiment, the metal coordination complex is a nobel metal complex, including ruthenium, rhodium, palladium, osmium, iridium, platinum, silver, copper or gold, preferably palladium or platinum. In at least one embodiment, the metal coordination complex is a combined coordination complex comprising at least one of the ferromagnetic, paramagnetic and nobel metal coordinated complexes discussed above.

In at least one embodiment, the step of depositing the metal coordination complex into the substrate surface comprises the sub-steps of: depositing the metal coordination complex onto the substrate surface; applying a magnetic field to the metal coordination complex so as to cause the ligands of the metal coordination complex to align and be drawn into the thickness of the substrate surface; tuning the magnetic field such that the ligands of the metal coordination complex are more aligned and more deeply drawn into the thickness of the substrate surface; and removing the magnetic field. In accordance with at least one embodiment, these sub-steps may be performed in any order, except that the step of removing the magnetic field preferably occurs after the metal coordination complex is applied to the surface of the substrate under the influence of the applied magnetic field.

In at least one embodiment, the magnetic field is applied by placing the substrate surface on or near a source of the magnetic field. Preferably, the magnetic field is orthogonal to the substrate surface. The magnetic field may be generated, for example, by one or more permanent magnets, electromagnets, or any combination thereof. Preferably, the field strength of the magnet is at least 1000 Gauss, and more preferably, is at least 2000 Gauss. Preferably, the magnet is a neodymium magnet. The magnet also has preferred dimensions such that the portion of the substrate surface is entirely contained within the dimensions of the magnet. In some embodiments, the magnetic field is substantially orthogonal to the portion of the substrate surface at all intersecting points and/or has a substantially uniform flux density. Preferably, the substrate and the magnet are positioned such that the substrate surface is not separated from the magnet by the remainder of the substrate, but is the closest part of the substrate to the magnet—although alternative configurations are contemplated.

In at least one embodiment, the magnetic field is a tunable magnetic field. In other words, the magnetic field flux density and structure is adjustable or tunable. In at least one embodiment, the metal coordination complex is reactive to the applied magnetic field, and in particular, to the structure (e.g. magnetic field flux density) of the magnetic field. Preferably, application of the tuned magnetic field causes the metal coordination complex to align according to the magnetic field structure (e.g. flux density). In at least one embodiment, the structure of the magnetic field may be selected based on, at least partially, the actual and/or desired structural alignment, shape, polarity and/or depth of the metal coordination complex within the substrate surface.

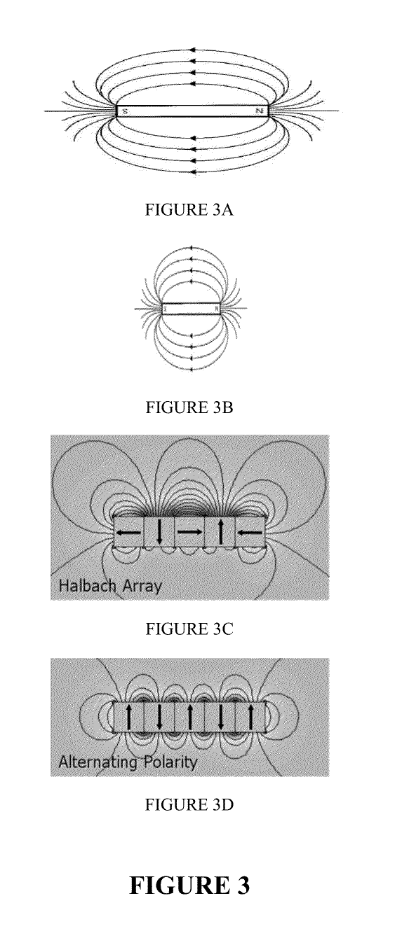

FIG. 3 illustrates exemplary tuned states of the magnetic field. As shown in FIGS. 3A and 3D, for example, the magnetic field may be adjusted between various tuned states. FIGS. 3A and 3B, for example, illustrate elliptical magnetic fields in flattened (FIG. 3A) and rounded (FIG. 3B) configurations, according to at least one embodiment. The different tuned states apply different magnetic forces (both in magnitude and direction) on the metal coordination complex, as illustrated by the magnetic field lines in FIG. 3. Accordingly, and based upon the characteristics of the metal coordination complex, increasing the amplitude and power within the electromagnetic field force electrons of the metal coordination complex to higher valence levels of bonding. To this effect, the magnetic field may be tuned to vary (e.g. make greater) the applied magnetic force, which in turn varies (e.g. makes stronger) bonding within the substrate surface.

In at least one embodiment, depending upon the molecule structure and polarity of the metal coordinated complex, each field state may generate different tangent sites within the substrate surface to share electrons, causing three different energy level bonding. Thus, tuning the magnetic field may comprise combining different electromagnetic field structures with different energy levels. For example, as shown in FIGS. 3C and 3D, a Halbach Array or Alternating Polarity array may be utilized to effect the advantages of the present invention according to at least one embodiment.

It should be noted, however, that the exemplary magnetic field structures described herein are provided for illustrative purposes, and all conceivable magnetic field structures. Moreover, as discussed above, the state of the tuned magnetic field may be selected according to the desired metal image to be formed. For example, if it were desired to electrolessly plate the entire substrate surface for the purpose of a semi-additive thin layer of plating, then the magnetic field may be tuned to reflect a more horizontal, flat, elliptical shape with a high level of power (or Gauss). However, if, for example, it were desired to electrolessly plate high density, fine features, then the magnetic field may be tuned to set the coordination complex molecular structure and alignment such that the plating would build up vertically, limiting side wall growth.

Without being held to any particular theory, it is believed that the metal coordination complex, under the influence of the magnetic field, will be drawn in toward the source of the magnetic field and thereby be more deeply injected into the substrate surface. Additionally, or in the alternative, the magnetic field may cause the ligands of the metal coordination complex to align in the direction of the magnetic field. Such alignment may further draw the ligands into the thickness of the substrate surface. A combination of the two processes may also occur. The result in any case is that the metal coordination complex is more tightly bound within the substrate surface than which would occur without the influence of the magnetic field.

In at least one embodiment, for substrate material commonly use in the electronics industry (e.g. glass, etc.), the metal coordination complex penetrates the thickness of the substrate surface in excess of a depth of 10%. In at least one embodiment, for substrate material commonly use in the electronics industry (e.g. glass, etc.), the metal coordination complex penetrates the thickness of the substrate surface in excess of a depth of 15%. In at least one embodiment, for substrate material commonly use in the electronics industry (e.g. glass, etc.), the metal coordination complex penetrates the thickness of the substrate surface in excess of a depth of 20%.

In at least one embodiment, after the metal coordination complex is applied to the surface of the substrate under the influence of the applied magnetic field, the source of the magnetic field is removed.

In at least one embodiment, the metal coordination complex may be deposited on the portion of the substrate surface via painting, spraying, roller applicator, or any other procedures known in the art or hereinafter developed. According to at least one embodiment, the metal coordination complex may be deposited on the portion of the substrate surface by inkjet printing.

In at least one embodiment, the metal coordination complex may be deposited on the portion of the substrate in accordance with the image to be formed in the substrate surface. For example, a mask may be used to deposit the metal coordination complex in accordance with the image to be formed. Accordingly, in some embodiments, the metal coordination complex is applied to the predetermined pattern formed in the substrate surface.

In at least one embodiment, the image comprises an electronic circuit design. Preferably, the electronic circuit is selected from the group consisting of an analog circuit, a digital circuit, a mixed-signal circuit and an RF circuit. Accordingly, at least one embodiment may be practiced to fabricate one or more of: analog circuits, digital circuits, mixed signal circuits, and RF circuits.

### Forming the Image in the Surface of the Substrate (Step 300)

As shown in FIG. 1, an image is formed in the surface of the portion of the substrate surface in accordance with Step 300. The image is a metal image formed of the metal coordination complex deposited within the substrate surface reduced to a zero oxidation state metal. An exemplary reducing agent and reduction process is described, for example, in U.S. Pat. No. 8,784,952 and U.S. Pat. No. 8,784,953, the entire contents and disclosures of which are herein incorporated by reference.

In at least one embodiment, the step of forming an image in the surface of the substrate comprises the following sub-steps: exposing the deposited metal coordination complex to electromagnetic radiation according to the image to be formed; removing the unexposed metal coordination complex so as to leave the metal image; and drying the substrate surface.

In at least one embodiment, the step of exposing the deposited metal coordination complex to electromagnetic radiation includes exposing the deposited metal coordination complex to at least one of: microwave radiation, infrared radiation, visible light radiation, ultraviolet radiation, X-ray radiation or gamma radiation. In some embodiments, the composition of the metal coordination complex may be such that the metal coordination complex is sensitive to a particular range of the electromagnetic spectrum. In addition, or alternatively, one or more sensitizers may be added to the metal coordination complex in association with it being disposed on the substrate, rendering the coordination complex photosensitive or, if the complex is inherently photosensitive, to render it even more so.

Exposure of the deposited metal coordination complex to electromagnetic radiation reduces the metal coordination complex to a zero oxidation state metal by activating the metal coordination complex toward a reducing agent. Exposure to radiation renders the exposed portion of the metal coordination complex susceptible to reduction. The reducing agent reduces the metal coordination complex to elemental metal. The reducing agent may be any metal-inclusive salt where the metal has a reduction potential that is greater, i.e., conventionally has a more negative reduction potential than the metal of the metal coordination complex. The result is that the exposed metal coordination complex is reduced to elemental metal according to the metal image.

In at least one embodiment, the step of removing unexposed (i.e. unreduced) metal coordination complex from the substrate surface comprises washing the surface with a solvent. The elemental metal image resulting from the exposure (i.e. reduction) step is preferably insoluble in most solvents. Thus, washing the surface of the substrate with an appropriate solvent, which is determined by the composition of the initial metal coordination complex, will remove unexposed complex leaving the metal image. The metal image may be evenly dispersed over the surface of the substrate if the surface of the substrate was generally exposed, or the metal image may form a discrete pattern if the substrate surface was exposed according to such.

In at least one embodiment, once the unexposed metal coordination complex is removed, the substrate is dried to complete formation of the metal image. In at least one embodiment, the step of drying the surface comprises drying at ambient or elevated temperature, preferably, using a vacuum chamber.

The metal image can then be plated with another metal or coated with a non-metallic conductive material.

### Depositing the Protective Material onto the Image (Step 400)

In advance of plating the metal image, a protective layer is preferably applied to the metal image (Step 400). This protective layer is preferably a conductive material. In at least some embodiments, the protective layer is a metal or conductive polymer that is applied by at least one of: flash deposit, vapor deposition, electrostatic bonding, or the like, all known in the art.

### Electroless Plating Metal onto the Image (Step 500)

As shown in FIG. 1, the protected elemental metal image is subjected to an electroless plating process in accordance with Step 500. In this manner a conductive metal layer is formed on the regions of the elemental metal image, resulting in a raised conductive surface. In at least one embodiment, depositing the conductive metal layer onto the substrate surface comprises an accelerated electroless deposition of metal onto the portion of the substrate surface, and/or the metal image comprising the reduced metal coordination complex.

In at least one embodiment, the raised conductive surface comprises an electronic circuit. Preferably, the electronic circuit is selected from the group consisting of an analog circuit, a digital circuit, a mixed-signal circuit and an RF circuit. Accordingly, at least one embodiment may be practiced to fabricate one or more of: analog circuits, digital circuits, mixed signal circuits, and RF circuits.

In at least one embodiment, electroless plating of the metal image is accomplished by applying to the substrate surface a solution of a salt of the metal to be deposited in the presence of a complexing agent (i.e. a complexed metal salt solution). Application of the complexed metal salt solution to the substrate surface may be by brushing, spraying, submerging or any other application process known in the art or hereinafter developed. An aqueous solution of a reducing agent may be simultaneously or consecutively to the substrate surface having the applied complexed metal salt solution. The metal complex is then reduced to afford elemental metal which adheres to the metal image already on the surface of the substrate—i.e. an electrolessly deposited layer of metal on metal results.

Preferably, the complexing agent keeps the metal ions in solution and acts to stabilize the solution, generally. The complexed metal salt solution and the reducing solution may be concurrently sprayed onto the patterned substrate either from separate spray units, the spray streams being directed so as to intersect at or near the substrate surface, or from a single spray unit having separate reservoirs and spray tip orifices, the two streams being mixed as they emerge from the spray tip and impinge on the substrate surface.

In at least one embodiment, electrolessly depositing the conductive metal layer onto the portion of the substrate surface comprising the reduced metal coordination complex comprises applying to at least the portion of the substrate surface comprising the metal coordination complex with a solution comprising a salt of the metal, a complexing agent and a reducing agent.

In at least one embodiment, electrolessly depositing the conductive metal layer onto the portion of the substrate surface comprises applying an electroless plating bath. The electroless plating solution/bath preferably includes: a pretreating/cleaning/etching solution for electroless plating comprising an alkali solution, a reducing agent and a completing agent; and a solution/bath of an electroless plating chemistry comprising a pH adjusting agent, a reducing agent, a metal ion and a completing agent.

In at least one embodiment, the pH adjusting agent is preferably selected from the group comprising: KOH, NaOH, Ca(OH).sub.2, NH.sub4 OH (with a hydrogen ion concentration (pH) of 10.5 to 14) or the like.

In at least one embodiment, the reducing agent is preferably selected from the group comprising: an aldehyde, hypophoshites (sodium or potassium), hydrogen borate, hydrazine, glyoxylic acid, dimethylamine borane (DMAB), borohydride, cobalt (II) ethylenediamine complex, (in a concentration of 2 to 8 percent mol/l) or the like.

In at least one embodiment, an accelerator may also be used, and is preferably selected from the group comprising: carboxylic acid, glycolic acid, acetic acid, glycine, oxalic acid, succinic acid, malic acid, malonic acid, citric acid, phosphinic acid and nitrilotriacetic acid (in a concentration of 1 to 20 percent mol/l) or the like.

In at least one embodiment, the complexing agent is preferably selected from the group comprising: EDTA, HEDTA, Rochelle salt, an organic acid, citric acid, tartaric acid, ammonium citrate, TEA, ethylene diamine, trialkyl monoamine, sodium potassium tartrate, triisopropanolamine, (in a concentration of 2 to 10 percent mol/l) or the like.

In at least one embodiment, the metal ion is a copper ion of copper compounds preferably selected from the group comprising: CuSO.sub.4 5H.sub.2O, CuO, CuCl.sub.2, Cu(NO.sub.3).sub.2, (in a concentration of 1 to 5 percent mol/l).

In at least one embodiment, the step of subjecting the substrate to an electroless plating process comprises agitating the plating solution (i.e. plating bath). Preferably, agitation includes nitrogen agitation for approximately 20 to 120 minutes, according to known methods in the art.

In at least one embodiment, the step of subjecting the substrate to an electroless plating process comprises filtering the plating solution (i.e. plating bath). This is preferably performed with a less than 1 micron filter, according to known methods in the art.

In at least one embodiment, the plating bath contains dissolved metal salts of the metal to be plated as well as other ions that render the electrolyte (i.e. metal salt) conductive.

When power is applied to the plating bath, including the submerged substrate surface portion, the metallic anode is oxidized to produce cations of the metal to be deposited and the positively charged cations migrate to the cathode, i.e., the metal image on the substrate surface, where they are reduced to the zero valence state metal and are deposited on the surface.

In an embodiment of this invention, a solution of cations of the metal to be deposited can be prepared and the solution can be sprayed onto the metalized construct.

The conductive material to be coated on the elemental metal image may also comprise a non-metallic conductive substance such as, without limitation, carbon or a conductive polymer. Such materials may be deposited on the metal image by techniques such as, without limitation, electrostatic powder coating and electrostatic dispersion coating, which may be conducted as a wet (from solvent) or dry process. The process may be carried out by electrostatically charging the metal image and then contacting the image with nano- or micro-sized particles that have been electrostatically charged with the opposite charge to that applied to the metal image. In addition, to further ensure that only the metal image is coated, the non-conductive substrate may be grounded to eliminate any possibility of an attractive charge developing on the substrate or the substrate may be charged with the same polarity charge as the substance to be deposited such that the substance is repelled by the substrate.

### EXAMPLE

An exemplary embodiment will now be described for illustration.

For the purpose of showing detailed information and design, the high speed electroless process will focus upon copper to be deposited at a higher rate than the industry norm, which is 1μ-3μ per hour, depending upon the electroless copper chemistries available on the market, and available. Electroless copper plating has been catalyzed, in the past, by an active palladium surface, and continues to deposit auto-catalytically on the newly reduced copper deposited. The deposition rate depends upon the half-reaction activity of the cupric ion reduction and formaldehyde oxidation on the active palladium and copper surfaces. The complexing agents can change the behavior of the half-reactions by stabilizing the cupric ion through complexation and by surface adsorption. Let's examine the complexing agents, ethylenediaminetetraacetic acid and triethanolamine (for example) on the electrochemical reduction of cupric ions and the oxidation of formaldehyde (as the reducing agent). It can also be asserted that change in pH will accelerate the deposition rate of the electroless copper. The pH of the solution influences the reduction potential through protonation of the coordinated complex or by the hydroxide acting as a ligand. The equilibrium potential for the formaldehyde oxidation becomes more negative with increasing pH. The use of a complexing agent in the bath is essential because it prevents the precipitation of the copper hydroxide under alkaline solutions. The ethylenediaminetetraacetic acid based electroless copper solution has a relatively low deposition rate, with a high bath stability, because of the strength of the complex with cupric ions (which is why it is used primarily in the PCB industry). The past challenge with triethanolamine is that it can conflict with the oxidation of formaldehyde and then inhibit the initial copper deposition on the active coordination complexes/catalysts. The triethanolamine based electroless copper solution achieves a higher deposition rate then the ethylenediaminetetraacetic acid based solution, however with the high pH (for acceleration of the deposition rate), it will remove or impair the coordinated complex/catalyst from being built upon by the cupric ions. Therefore, combining the complexing agent solutions can mitigate the stability issues, or by sealing the coordination complex/catalyst with copper, which will allow the accelerated electroless copper build up, either will overcome the challenge of the triethanolamine based electroless copper solution. In the case of the combination of complexing agents, the deposition rate increases as the mole ratio of triethanolamine to ethylenediaminetetraacetic acid increases and the bath stability is maintained. Any uneven deposition of copper on the activated surface can be enhanced by adjusting the operating temperature and pH of the bath. The net rate of deposition of the high speed electroless copper plating occurs at the mixed potential when the cathodic and anodic currents are equal.

Experimental Parameters:

Target pH of solutions should be in the range of 11 to 13 using NaOH or H2SO4

Target temperature range should be 45° to 70° C. (preferably 55° C.)

Strong Nitrogen Agitation

Ratio of components: 1 part copper (0.04M cupric sulfate), 3 parts reducing agent (0.12M formaldehyde), and 5 parts complexing agent(s) (0.20M ethylenediaminetetraacetic acid and triethanolamine mix) Note: All solutions to be prepared with analytical grade reagents and deionized water.

Use a 5 minute dip of the solution consisting of the Shipley Cuposit 328 material as follows: 328 A 12.5% by volume, 328 L 12.5% by volume, 328 C 2.5% by volume, H2O (De-Ionized) 72.5% by volume, as the sealant to the aggressive pH in the triethanolamine solution prior to the high speed copper electroless tank.

The reduction performance of cupric ions in alkaline solutions depends on the characteristics of the complexing agents utilized. This is because of the different complexing abilities as evidenced by their formation constants with cupric ions. Without the protective sealant step after the initiation of the coordinated complex/catalyst, aggressive deposition would be problematic, however with the institution of this step then the deposition rate can approach 20μ per hour (with increased temperature and pH). By combining the complexing agents to make up an aggregate complexing agent with a mixed potential, the oxidation of the reducing agent is still independent of the complexing agents but can be accelerated by increasing pH of the bath. Ethylenediaminetetraacetic acid and sodium potassium tartrate, both have a high formation constant with cupric ions, and therefore a complexing agent based electroless copper process has a lower deposition rate and better bath stability with either of these complexing agents. The complexing ability of triethanolamine or triisopropanolamine is much lower than that of ethylenediaminetetraacetic acid and sodium potassium tartrate, and also could be detrimental to the coordination complex/catalyst activation of the substrate surface, unless the process step of using a protective layer over the coordination complex/catalyst precedes the high speed electroless bath. With the different testing of the potential combinations of complexing agents and reducing agents by the above mentioned ratios, it is clear that the deposition rate increased with the mole ratio between the aggressive complexing agents and the complexing agents that promote stability. The surface coverage and speed of deposition was also adjusted by the operating temperature and pH of the bath (as it increased).

In at least one embodiment, depositing a conductive material onto the substrate surface comprises deposition of a non-metallic conductive substance onto the portion of the substrate surface, or the image that encompassed or comprising the reduced metal coordination complex. In at least one embodiment, the non-metallic conductive material is deposited onto the portion of the surface comprising the reduced metal coordination complex by electrostatic dispersion. In at least one embodiment, the entire non-conductive substrate surface is activated and the metal coordination complex is deposited onto the entire surface. In at least one embodiment, the entire non-conductive substrate surface is activated and the metal coordination complex is deposited on a part of the activated surface.

The enablements described in detail above are considered novel over the prior art of record and are considered critical to the operation of at least one aspect of the invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

As used herein, any term of approximation means that the word or phrase modified by the term of approximation need not be exactly that which is written but may vary from that written description to some extent. The extent to which the description may vary will depend on how great a change can be instituted and have one of ordinary skill in the art recognize the modified version as still having the desired properties, characteristics and capabilities of the word or phrase unmodified by the term of approximation. In general, but with the preceding discussion in mind, a numerical value herein that is modified by a word of approximation may vary from the stated value by plus-or-minus 10% unless expressly stated otherwise.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that the named inventor believes that the claimed subject matter is what is intended to be patented.

What is claimed is:

1. A method of conductive image using high speed electroless plating comprising the steps of:
preparing the surface of a substrate, the substrate surface having a thickness;
depositing a metal coordination complex within the surface of the substrate;
reducing the metal coordination complex to form a metal image in the surface of the substrate;
depositing a protective material onto the metal image; and
electrolessly plating metal onto the metal image.
